(19) United States
(12) Patent Application Publication
(10) Pub. No.: US 2008/0309786 A1
(43) Pub. Date: Dec. 18, 2008

(54) METHOD AND APPARATUS FOR IMAGE PROCESSING

(75) Inventors: Fitzgerald J. Archibald, Thuckalay (IN); Biju Moothedath Gopinath, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 12/139,635

(22) Filed: Jun. 16, 2008

Related U.S. Application Data
(60) Provisional application No. 60/944,158, filed on Jun. 15, 2007.

(51) Int. Cl. H04N 5/228

(52) U.S. Cl. 348/222.1; 348/E05.032

(57) ABSTRACT

Digital camera audio/visual capture includes bandpass and notch filtering for the audio input during camera lens motor operation; the filtering may be active during capture or the audio segments may be marked for later noise suppression processing.

### CROSS-REFERENCE TO RELATED APPLICATIONS

This application claims priority from provisional application No. 60/944,158, filed Jun. 15, 2007, which is herein incorporated by reference.

### BACKGROUND OF THE INVENTION

The present invention relates to digital signal processing of audio and speech, and more particularly to architectures and methods for digital camera front-ends.

Imaging and audio/visual capabilities have become the trend in consumer electronics. Digital cameras, digital camcorders, and camera cellphones are common, and many other new gadgets are evolving in the market. Advances in large resolution CCD/CMOS sensors coupled with the availability of low-power digital signal processors (DSPs) has led to the development of digital cameras with both high resolution image and short audio/visual clip capabilities. The high resolution (e.g., sensor with a 2560×1920 pixel array) provides quality offered by traditional film cameras.

FIG. 3a shows typical functional blocks of digital camera control and image processing (the “image pipeline”). The automatic focus, automatic exposure, and automatic white balancing are referred to as the 3A functions; and the image processing includes functions such as color filter array (CFA) interpolation, gamma correction, white balancing, color space conversion, and JPEG/MPEG compression/decompression (JPEG for single images and MPEG for video clips). A lens stepper motor moves the lens to adjust focus (optical zoom), and a (directional) microphone picks up sounds from the scene being imaged for audio/visual recording.

Typical digital cameras provide a capture mode with full resolution image or audio/visual clip processing plus compression and storage, a preview mode with lower resolution processing for immediate display, and a playback mode for displaying stored images or audio/visual clips.

In movie capture applications, sound is recorded along with and synchronized to the captured video frames. The sound signal is converted to an electrical signal by the microphone and then converted to a digital signal by an ADC. Often, the intent of movie capture is to record speech associated with the video (either verbal comments of the camera operator or speech of the human subjects in the scene under movie capture). While capturing video, it is possible to adjust lens focus (zoom in/zoom out). When active, the lens stepper motor causes audible noise which gets added onto the speech signal that is picked up by the microphone and recorded. The microphone also picks up background noises of various types.

However, digital cameras typically have limited computing power and limited battery life, and this implies a problem for effective noise suppression (both audio and visual).

### SUMMARY OF THE INVENTION

The present invention provides mitigation of digital camera lens motor noise by activation of bandpass filtering, and cascaded band-pass and notch filtering to enhance speech intelligibility and/or use of different filter bank based on camera activity or nature of noise (e.g. zoom in and zoom out) and/or use of Automatic Level Controller (ALC) to maintain signal energy during filter operations and/or marking the audio recorded during lens motor operation for later noise suppression processing.

### BRIEF DESCRIPTION OF THE DRAWINGS

FIGS. 1a-1c show camera components plus filter and a filter cross-coherence for noisy input.

FIGS. 2a-2b are flowcharts.

FIGS. 3a-3c show functions of a image pipeline, processor, and internet communication.

FIGS. 4a-4c show a lowpass filter characteristics.

FIGS. 5a-5c illustrate a highpass filter characteristics.

FIGS. 10a-10b show experimental results.

FIG. 11 shows lens motor noise spectrum.

FIGS. 12a-12b are block diagrams of hardware implementations.

### DESCRIPTION OF THE PREFERRED EMBODIMENTS

### 1. Overview

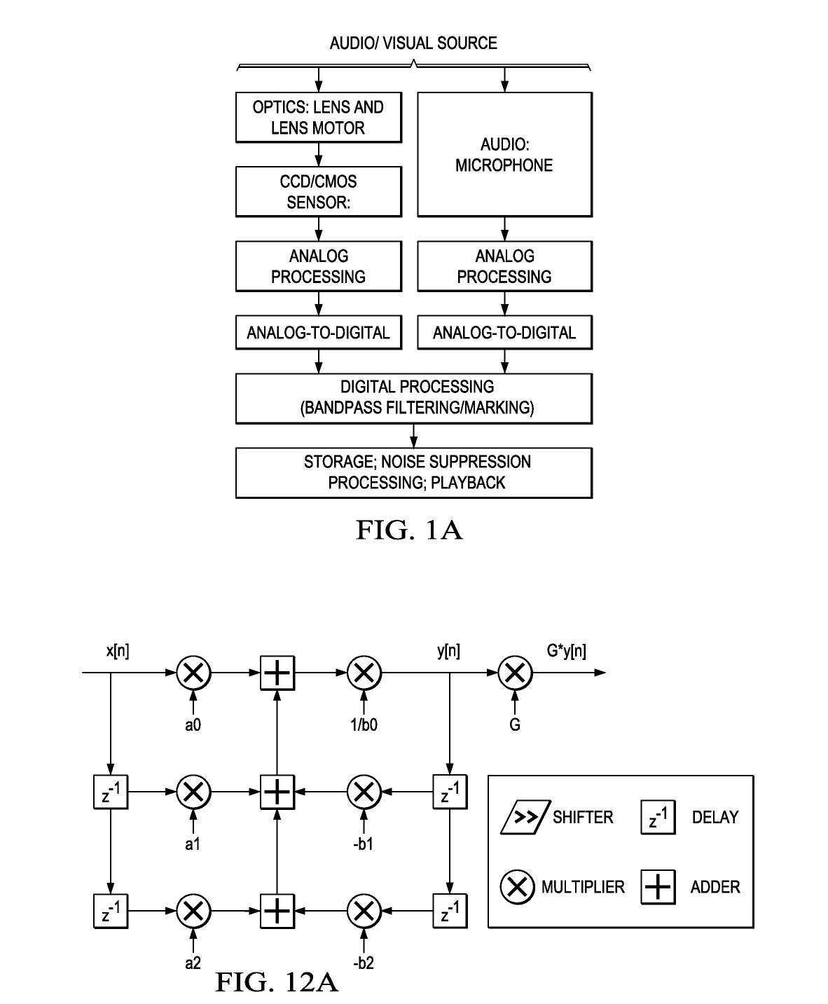

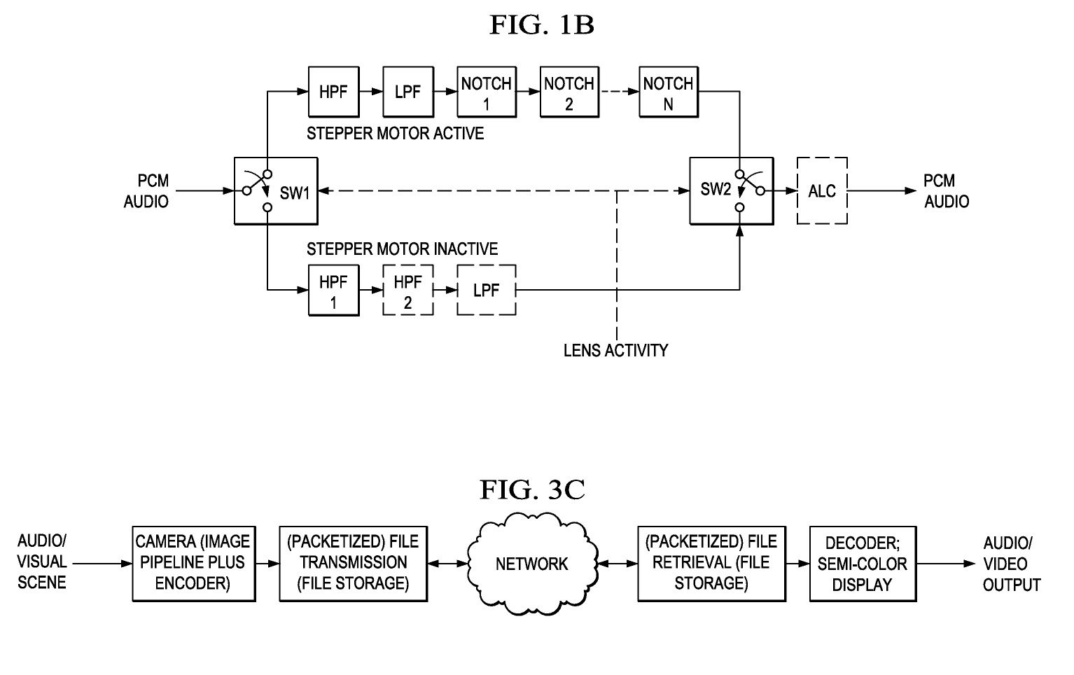

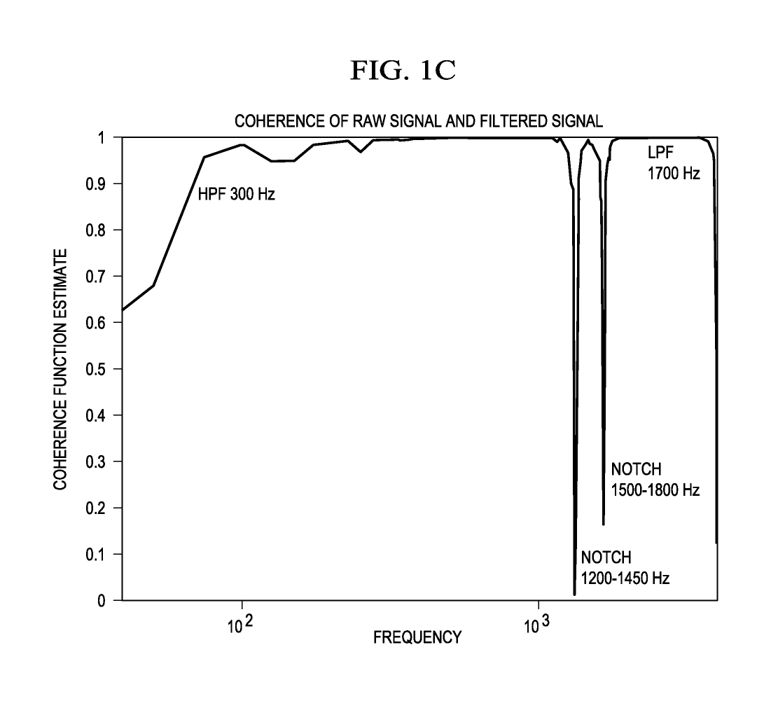

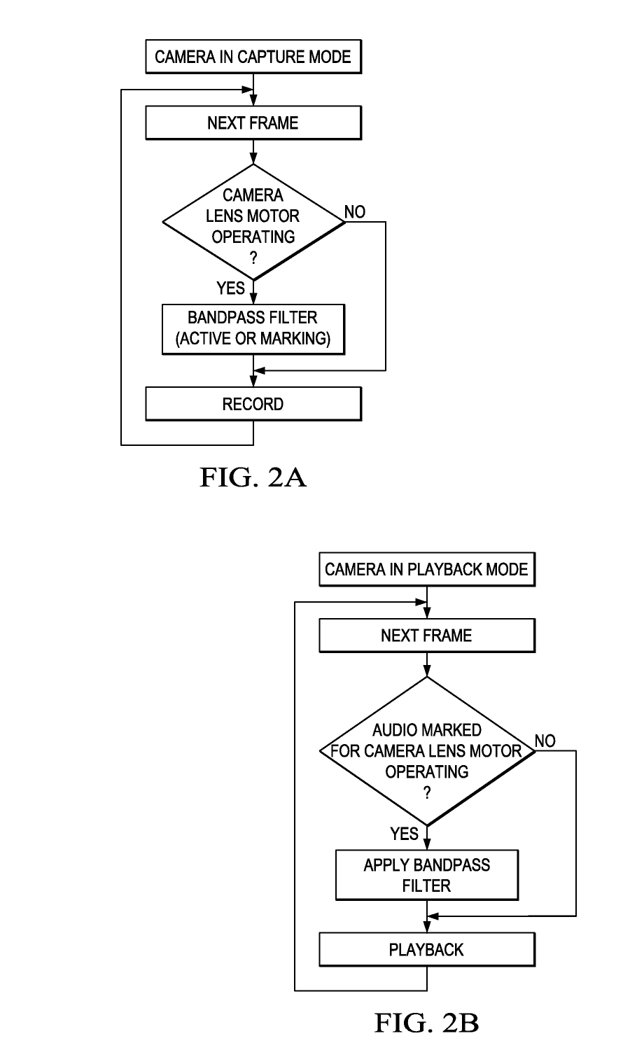

Preferred embodiment methods of lens motor noise mitigation for digital cameras apply: (1) bandpass filtering to the audio input recorded during camera lens motor operation in order to make speech more intelligible and/or (2) cascaded bandpass and multiple stages of notch filters to get desired magnitude spectrum and/or (3) use of multiple stages of HPF or LPF to get desired attenuation and magnitude curve and/or (4) use of noise masking principles to reduce the number of filter stages and/or (5) Automatic level control to maintain signal energy after filtering noise and/or (6) filter bank selection based on camera activity/noise characteristic and/or (7) hardware and software realization cascaded filter stages and/or (8) marking of such audio segments for later noise suppression processing or bandpass filtering during playback. FIGS. 1a-1b show functional blocks plus a preferred embodiment filter structure, and FIGS. 2a-2b are flowcharts for filtering during recording and during playback, respectively.

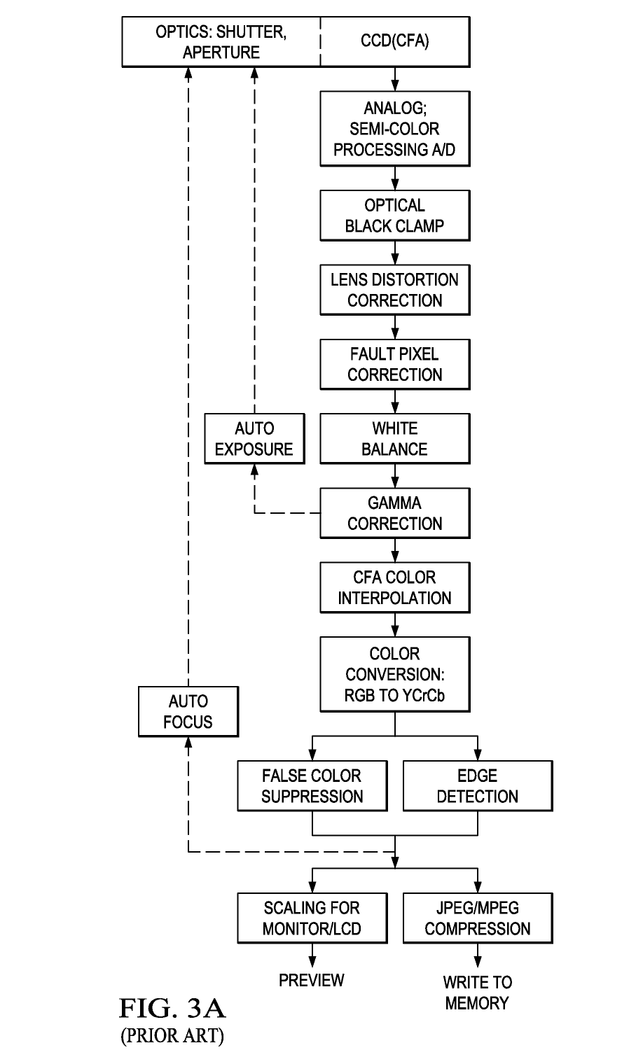

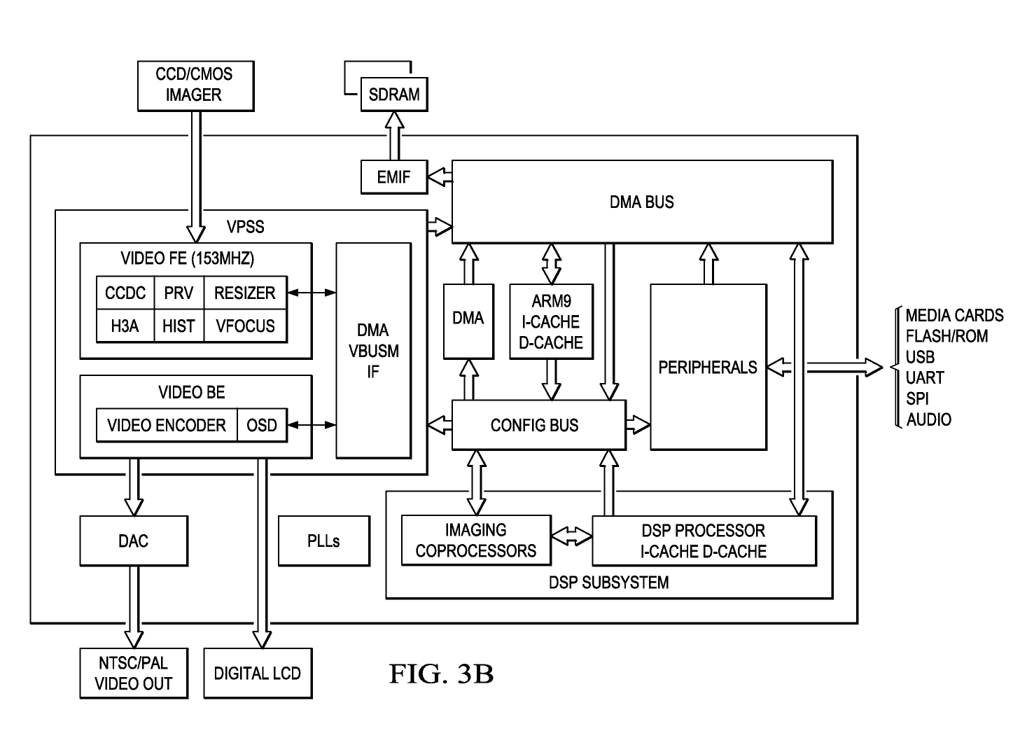

Preferred embodiment systems (camera cellphones, PDAs, notebook computers, et cetera) perform preferred embodiment methods with any of several types of hardware: digital signal processors (DSPs), general purpose programmable processors, application specific circuits, or systems on a chip (SoC) such as combinations of a DSP and a RISC processor together with various specialized programmable accelerators. FIG. 3b is an example of digital camera hardware. A stored program in an onboard or external (flash EEP)ROM or FRAM could implement the signal processing. Analog-to-digital converters and digital-to-analog converters can provide coupling to the real world, modulators and demodulators (plus antennas for air interfaces) can provide coupling for transmission waveforms, and packetizers can provide formats for transmission over networks such as the Internet; see FIG. 3c.

### 2. Bandpass Filtering

FIG. 1 illustrates simplified initial functional blocks of a digital camera for audio/visual capture; functions such as image resizing, raw data compression and storage, et cetera are not shown. For the case of a camera cellphone, the audio input is necessarily physically close to the video input lens system, so lens motor noise will be picked up by the audio input microphone. The preferred embodiments provide mitigation of this lens motor noise.

Preferred embodiment cameras and methods have objectives including:
(1) Lens motor noise filtering to minimize the noise in the speech signal.
   (a) While recording speech, minimize audibility of noise caused by lens motor.
   (b) The processor cycles requirement for lens motor noise filtering should be less than a small threshold.
(2) The lens motor noise filter shall have enable/disable controls.
   (a) The filter is turned on based on application preference.
(3) Speech intelligibility shall be preserved when the lens motor noise filter is enabled.
(4) The lens motor noise filter shall support 8 KHz and 16 KHz sampling rates for the audio signal.
(5) Provide option to minimize motor noise on playback of speech captured without lens motor noise filter enabled.

The effect of lens motor noise audibility, added to a captured speech signal, depends on:
(1) microphone characteristic
(2) ADC/DAC filter characteristic
(3) lens motor noise characteristic
(4) microphone and motor placement
(5) camera casing (sound absorption properties of material, and cabinet) speech signal characteristics.

Additive noise has a spectrum which adds onto the speech spectrum:

X_{noisy}(k)=X(k)+N(k)

and various noise suppression methods are known, such as spectral subtraction.

Noise may be stationary or non-stationary. Stationary noise characteristics remain the same with respect to time and spectrum; whereas, non-stationary noise characteristics vary with time and/or spectrum.

Microphone rumble noise is low frequency sound caused by wind, speaker is close to microphone, and/or mechanical sounds. Rumble noise (<100 Hz) typically lies outside speech spectrum. Thus the fundamental frequency of rumble can be filtered out by highpass filter with a low cut-off frequency.

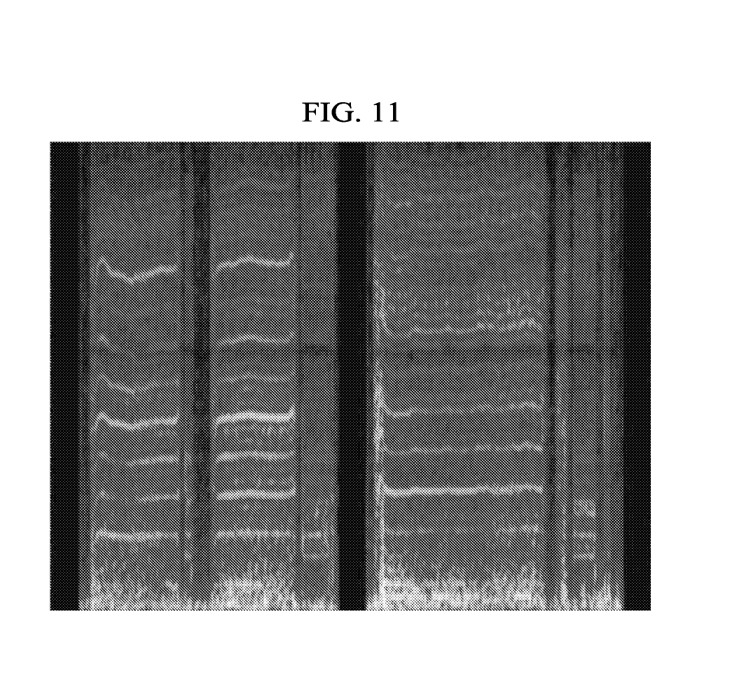

Lens motor noise is wideband with frequency content existing over the entire speech spectrum. The noise can be considered as segmented stationary noise (i.e. the noise when taken in short time windows remains stationary). The lens motor noise further has the characteristic of having significant power at low frequencies, high frequencies, and distributed narrow-band noise as shown in FIG. 11 where the noise power is 20 dB and with a sampling rate of 8 kHz.

By reducing the noise power outside of the speech spectrum, the SNR for the speech signal can be improved. The speech signal bandwidth is about 50-5000 Hz. The prominent speech section is around 150-3500 Hz which is the telephone voice band. By band-limiting (i.e., bandpass filtering) the audio input signal to 100-5000 Hz, noise power can be reduced without adversely affecting the speech signal. This increasing SNR increases speech intelligibility within the noisy input audio signal. Indeed, bandpass filtering to an even narrower band, such as 150-3500 Hz, will further increase speech intelligibility.

Since, the lens motor is controlled within the camera, the start time and duration for which the lens motor is running is known in the camera processor. Thus, lens motor bandpass filtering only needs to be turned on during the operation of lens adjustment. This limited duration bandpass filtering would aid in preserving a natural (e.g., wideband) sound of speech when the lens motor is inactive and speech intelligibility is less of a problem.

Band-limiting the ADC output is effective for speech signals embedded in background noise. Note that anti-aliasing analog filters may precede some types of ADC (and could be part of the microphone high-frequency roll-off), but the filter cut-off frequency would correspond to one-half of the sampling rate regardless of lens motor noise.

### 3. Speech Recorder

Analog microphone output is converted to digital data by analog-to-digital converters (ADCs). ADCs for audio are typically delta-sigma modulators with decimation filters (to convert oversampled digital data to the desired sampling rate), and gain controllers (preamp) and optional anti-aliasing filters (to attenuate high frequency noise).

### (1) Anti-Aliasing Filter on Input

In-order to prevent aliasing resulting from the downsampling in ADC, the digital data needs to be band-limited to the Nyquist rate (half-sampling rate).
(2) ADC Filter

The decimation filter in a delta-sigma ADC would act as a lowpass filter with cut-off at half the sampling rate. Thus in the case of 8 KHz sampling rate for the ADC setting, the speech signal is limited to 4 KHz maximum frequency. However, in case of 16 KHz sampling rate the ADC output contains frequency components up to 8 KHz.

### (3) Lowpass Filter

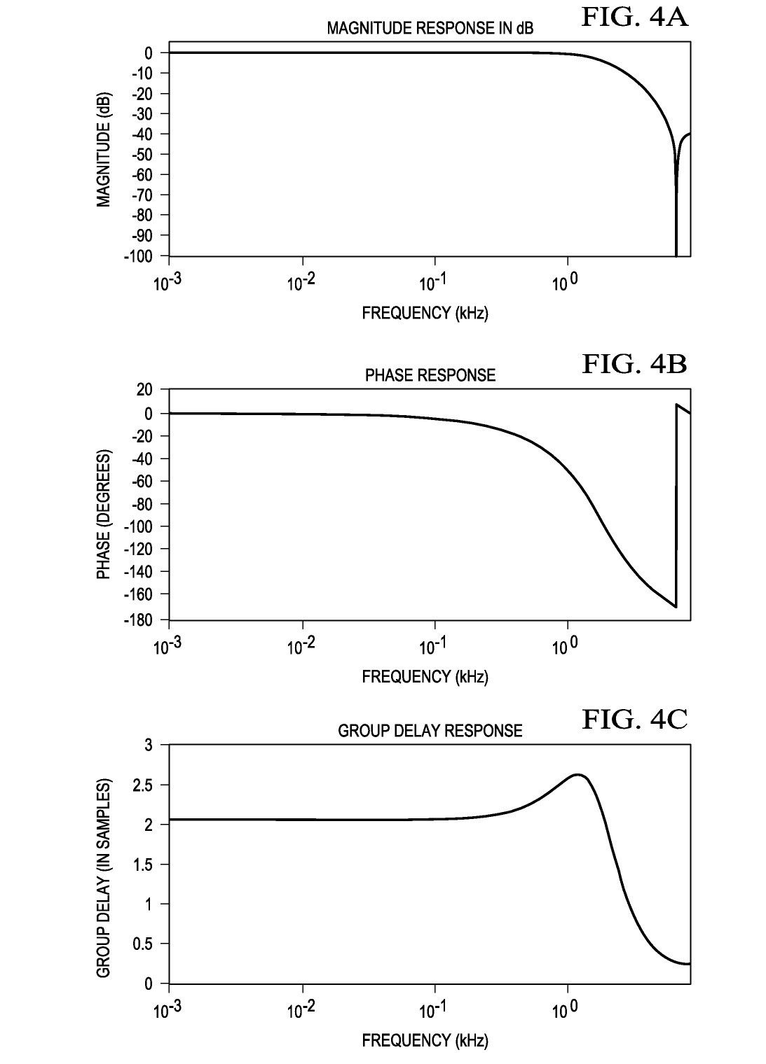

In order to limit the signal bandwidth to that of the prominent speech signal, so as to reduce noise power (increase SNR), a low-pass filter would be needed. FIGS. 4a-4c illustrate characteristics of a lowpass filter realized using an IIR biquad structure.

### (4) Bandpass Filter

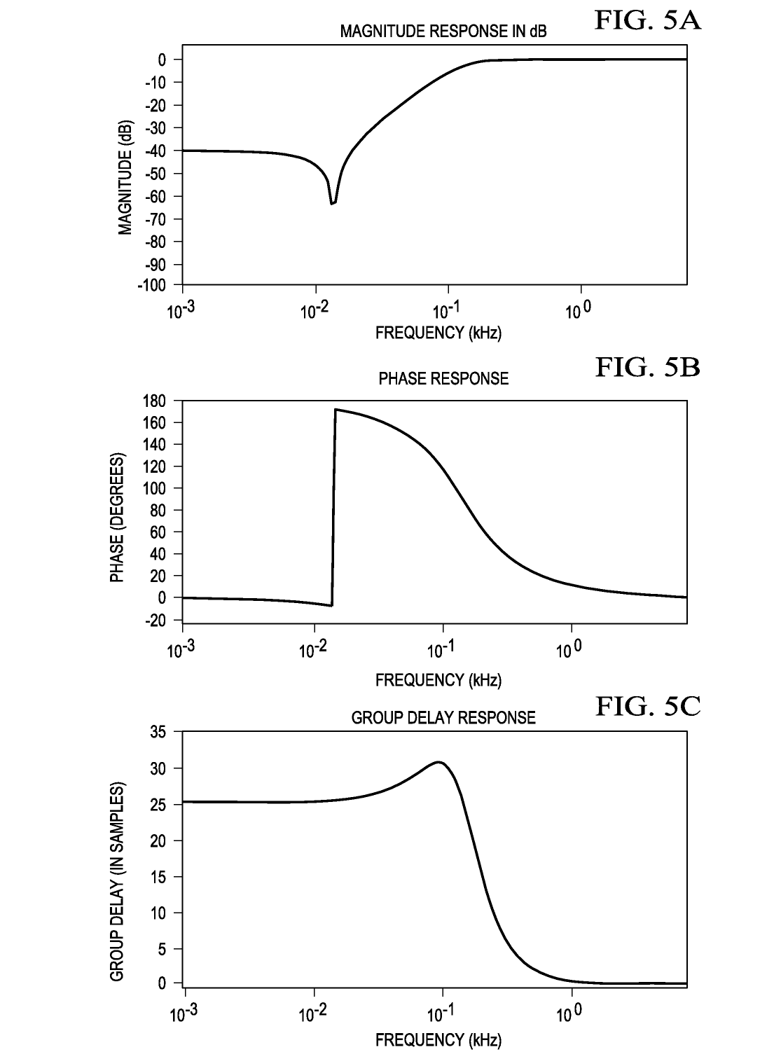

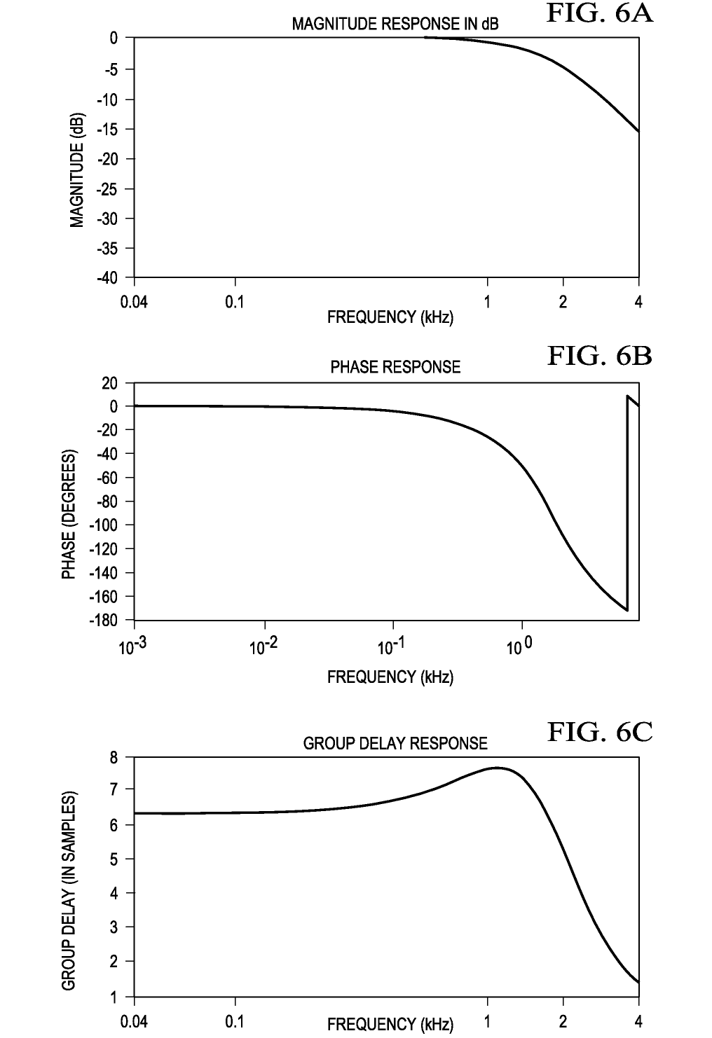

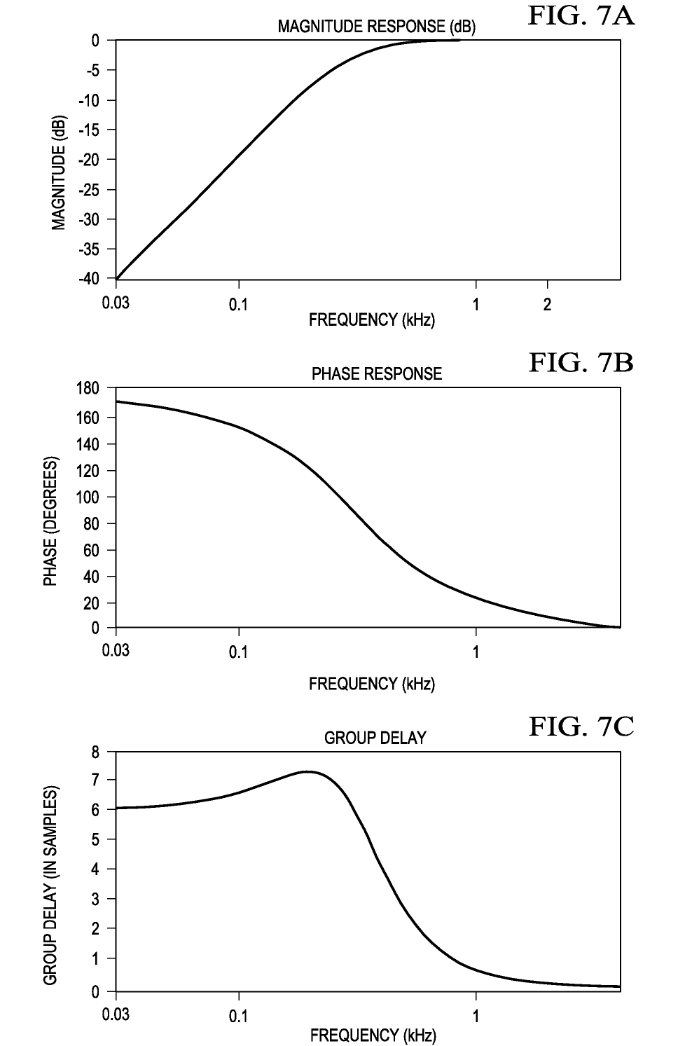

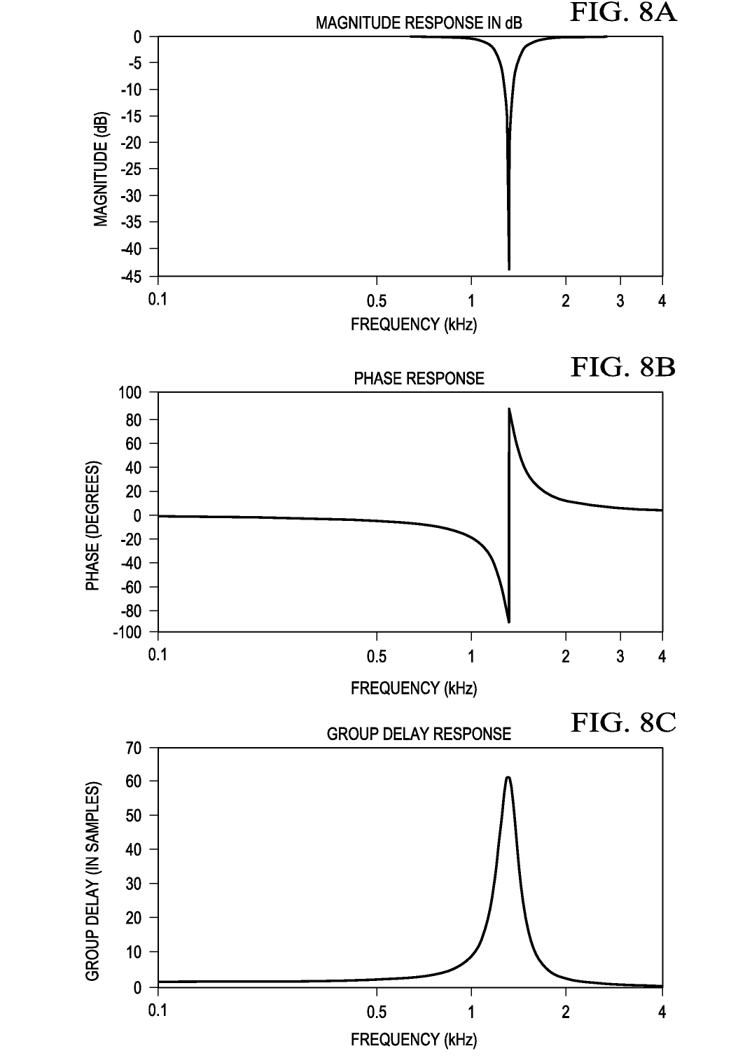

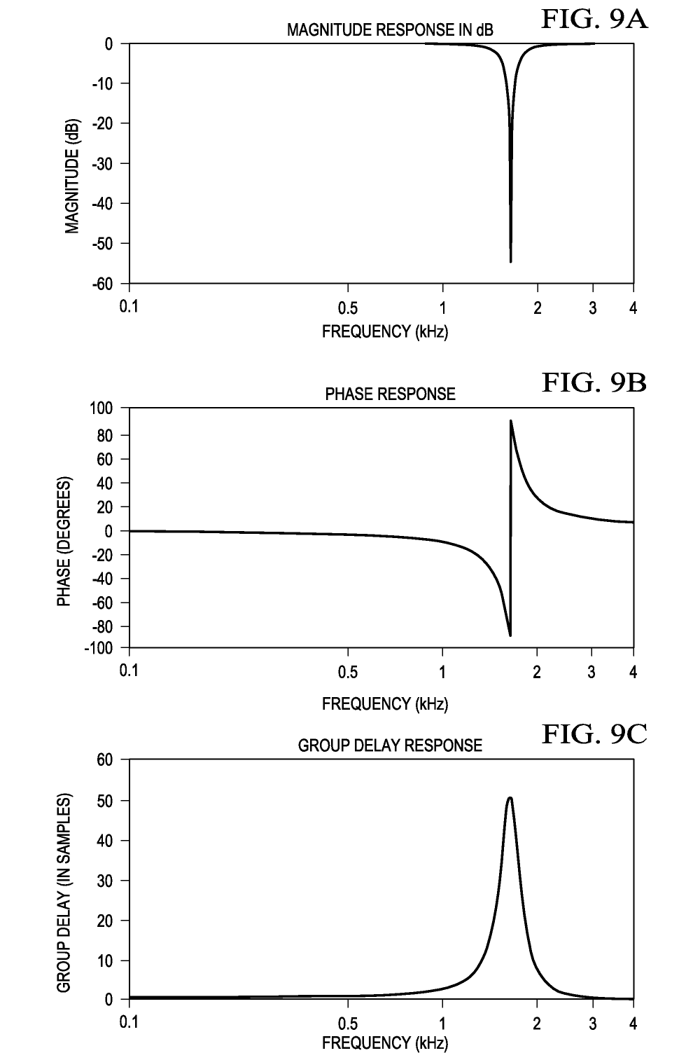

The low frequency noise can be removed by the use of a highpass filter, without affecting signal power. Thus a bandpass filter is suitable for improving SNR and speech intelligibility. The bandpass filter can be realized by cascading the lowpass and highpass filters shown in FIGS. 4a-4c and FIGS. 5a-5c, respectively. A second stage of highpass filter can be added if the noise has significant power density at low frequencies (0-100 Hz).

### (5) Cascade of Bandpass and Bandstop (Notch) Filters

As can be seen from FIG. 11, an efficient filtering for lens motor noise should incorporate highpass, lowpass, and notch filters. The highpass filter is needed for reducing/removing lens motor noise energy contained in low frequencies and microphone rumble. If the noise energy is too high, cascaded two stages of highpass filters can be used. The lowpass filter with gradual attenuation can be used for reducing noise energy at high frequencies (2200-3800 Hz in FIG. 11). Notch filters can be used for removing noise energy in narrow bands (1000-1100, 1300-1450, and 1600-1800 Hz in FIG. 11).

FIG. 1b illustrates the cascading of filter stages, and FIG. 1c shows a cascaded filter response. During the lens stepper motor operation (for zoom in and out), PCM (pulse code modulation) samples are passed through cascaded filter stages. In the case of buffering between ADC and the filter stages, the cascaded filter has to be active for additional time due to the duration of buffered samples. This is typically required when the filters are implemented in software. When filters are implemented in software there will be buffering of PCM samples between the ADC and the filter.

In normal recording without zoom operations (lens stepper motor is inactive), 1- or 2-stage highpass filters can be used to eliminate microphone rumble. Additionally, highpass filters can be used to reduce or minimize background noise (stationary and non-stationary).

### (6) Lens Motor Noise Marking

To facilitate advanced filtering options available on PCs, which typically have much greater processing power than digital cameras, the raw unfiltered audio data would be useful. In this case, the camera will mark the audio segments in the container (e.g. Quicktime) wherein the lens motor noise is present. The bandpass filtering on the camera recorder is either disabled or the noise marking is added in addition to the bandpass filtering. By disabling the bandpass filtering, non-speech data can be recorded in natural form within the allowed frequencies for the selected sampling frequency.

### 4. Speech Playback

In the playback path of the camera, the bandpass filter is activated if it had been disabled during capture of the audio segment and the audio segment contains noise marking; see FIG. 2b. This provides the same speech intelligibility enhancement described above.

In the case of transfer of movies captured by the digital camera to a PC, a software module running on the PC can be used for post-processing the recorded audio for enhancing SNR by known noise suppression methods, such as spectral subtraction. The enhanced audio can then replace the audio stored within the container.

### 5. Cascaded Bandpass and Notch Filter Implementation

Second order IIR lowpass and highpass filters can be used in cascade to realize the bandpass filter as shown in FIG. 1b. FIR filters would require the order of filter, and hence computation, to be higher to achieve the same frequency response.

Alternatively, biquad filters can be used for realizing different frequency responses by programming the coefficients. Recall that a biquad filter has a transfer function as a ratio of two quadratics:

H(z)=(b₀+b₁z¹+b₂z²)/(a₀+a₁z¹+a₂z²)

There are only five independent coefficients, and typically either b₀ or a₀ is taken equal to 1. Solving Y(z)=H(z)X(z) for y[n] gives the usual IIR filter implementation form (for b₀=1):

y[n]=a₀*x[n]+a₁*x[n 1]+a₂*x[n 2]b₁*y[n 1]b₂*y[n 2]

FIG. 4a shows the magnitude response of a lowpass biquad with filter coefficients as follows: a₀=0.0793, a₁=0.1335, a₂=0.0793, b₁=−1.1064, b₂=0.3983. Note that the frequency roll-off in FIG. 4a starts about 2 kHz and is down to 26 dB at 5 kHz. The speech intelligibility is maintained, whereas the noise energy is reduced. FIGS. 4b-4c show the phase and group delay.

FIG. 5a shows the magnitude response of a highpass biquad with filter coefficients as follows: a₀=0.9617, a₁=−1.9233, a₂=0.9617, b₁=−1.9219, b₂=0.9248. The frequency roll-off in FIG. 5a starts about 120 Hz and is down to 19 dB at 50 Hz. This provides significant low frequency noise attenuation with a single stage. The speech signal energy is preserved. FIGS. 5b-5c show the phase and group delay.

When the noise energy contained in low frequency is removed and noise energy at high frequency is reduced, the increased SNR of the output signal allows for masking of the noise signal while preserving intelligibility of speech. Cascading the filters of FIGS. 4a-4c and FIGS. 5a-5c effectively multiplies the transfer functions and gives a preferred embodiment speech-enhancing bandpass filter for use in a camera which preserves 150-2000 Hz and has rolled-off to about 20 dB at 50 and 4000 Hz.

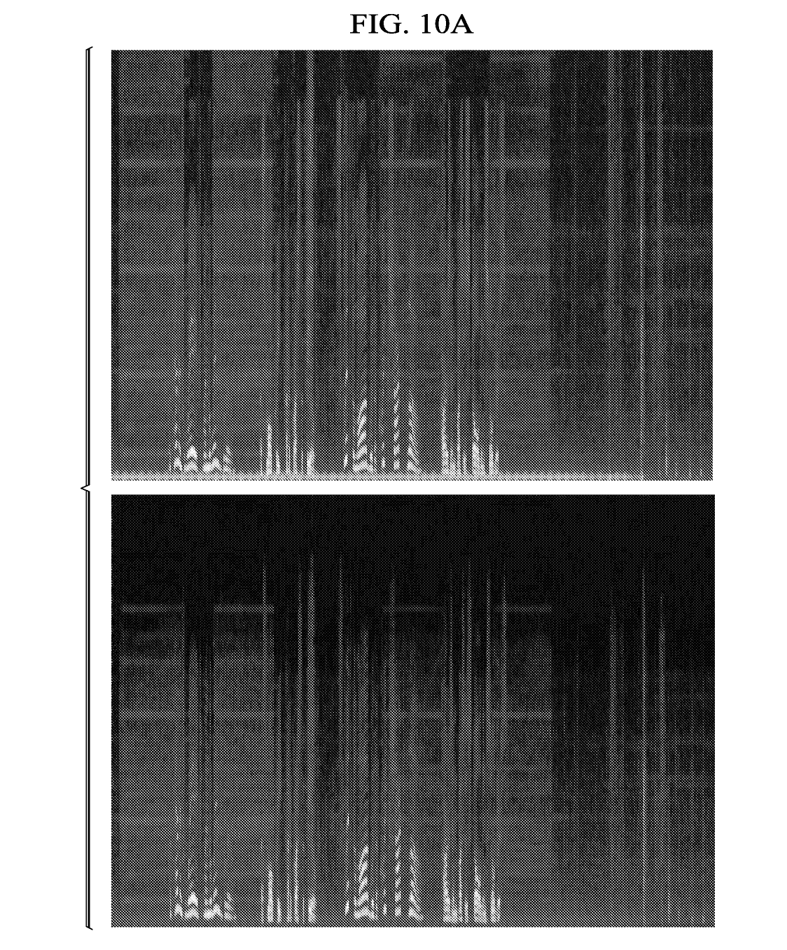

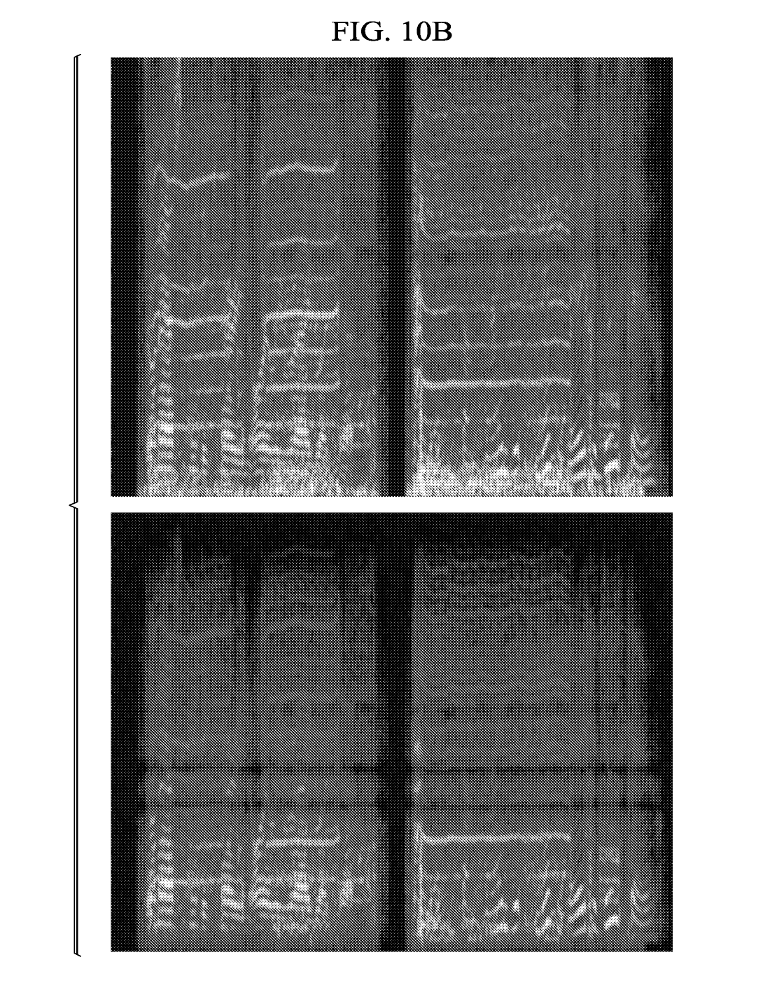

FIG. 10a shows experimental results for a speech signal embedded in motor noise, sneeze, and thud on the microphone. The upper panel shows the histogram prior to filtering, and the lower panel the histogram after speech-intelligibility filtering. The filter was a cascade of a Chebyshev-II second order lowpass filter and a second order IIR highpass filter. Sampling rate of input signal is 16 KHz.

FIG. 6a-6c shows the filter response of HPF with coefficients as follows: a₀=0.846459, a₁=−1.692918, a₂=0.846459, b₁=−1.669203, b₂=0.716633. The cut-off frequency is at 300 Hz, and attenuation is around 20 dB at 100 Hz. The group delay is small and the phase response is close to linear. A cascade of 2 stages of the same HPF filter would provide attenuation of 40 dB at 100 Hz.

FIG. 7a-7c shows the filter response of LPF with coefficients as follows: a₀=0.227117, a₁=0.454235, a₂=0.227117, b₁=−0.276664, b₂=0.185136. The cut-off frequency is at 1700 Hz, and attenuation is around 10 dB at 3 KHz. The LPF has slower roll-off compared to HPF in order to maintain the speech signal energy at high frequencies which is important for intelligibility. The group delay is small.

FIG. 8a-8c shows the filter response of notch filter with coefficients as follows: a₀=0.910339, a₁=−0.925094, a₂=0.910339, b₁=−0.925094, b₂=0.820678. The cut-off frequency is at 1200, 1450 Hz with as much as 40 dB attenuation at the centre of stop-band. The purpose of band-stop or notch filters is to reduce the noise energy by attenuating the frequencies where noise energy is concentrated. The impact on speech signal is minimal with respect to intelligibility and signal energy since speech signal consists of fundamental and harmonics.

FIG. 9a-9c shows the filter response of notch filter with coefficients as follows: a₀=0.894168, a₁=−0.488815, a₂=0.894168, b₁=−0.488815, b₂=0.788336. The cut-off frequency is at 1500, 1800 Hz with as much as 50 dB attenuation at the centre of stop-band.

The cascade of filters in FIG. 6a-6c, FIG. 7a-7c, FIG. 8a-8c, and FIG. 9a-9c would result in the cross-coherency as shown in FIG. 1b-1c. This bandpass plus notch filtering as in FIGS. 1b-1c enhances noisy speech intelligibility in the presence of lens motor noise by preserving the prominent speech band while suppressing everything outside of this band.

FIG. 10b illustrates noise reduction by use of cascaded second order Butterworth filters: highpass filter with cut-off frequency at 300 Hz, lowpass filter with cut-off frequency at 1700 Hz, and two bandstop (notch) filters with cut-off frequencies 1500-1800 Hz and 1200-1450 Hz. The input signal is additive lens motor noise and speech signal sampled at 8 kHz. FIG. 1c provides the cross-coherence of input and output signals.

Scaling may follow the filtering to achieve unity gain. Biquad filters can easily be implemented in fixed-point software or hardware.

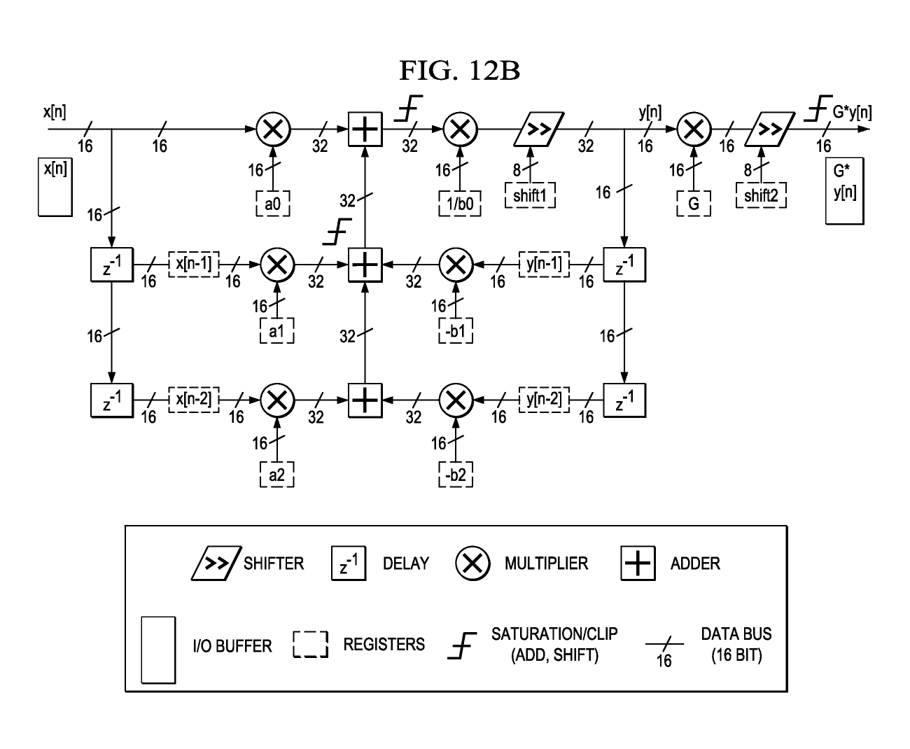

In order to reduce gate count for cascaded filters in hardware, loopback can be used with programmability of coefficients and context (past output and input samples) save/restore features makes only a single hardware stage necessary. FIGS. 12a-12b are block diagrams of a hardware implementation.

### 6. Summary

The computational complexity required by spectral domain noise subtraction is not affordable in most digital cameras. Also, the nature of noise is variable as can be seen above.

With the addition of highpass filtering in the case of audio sampled at 8 kHz or a bandpass filter with bandwidth covering the prominent speech spectrum in the case of 16 kHz sampling, the background noise power can be reduced to improve SNR and intelligibility of the speech signal. In the case that the natural sound needs to be preserved and only the lens motor noise is to be eliminated, the bandpass filter can be turned on only during the periods of motor operation.

Filter design can take advantage of Equal Loudness Curves which indicate that the human ear is most sensitive to sound in the 3-4 kHz band. A second order IIR lowpass filter does not have a sharp cut-off, so use gradual attenuation starting around 3 kHz. The low pass filter can be used for signal sampled at rates starting from 4 KHz.

The highpass filter eliminates low frequency noises like rumble and wind noise from the signal captured by the microphone. In the case the noise attenuation is not sufficient with a single stage highpass, use cascaded highpass stages of second order IIR filters.

Narrow band noises (e.g., hum) can be eliminated by the use of notch filters. The biquad filter structure can be programmed for notch filter realizations.

After filter stages, an optional automatic level controller (ALC), as shown in FIG. 1b, can be used to boost the speech signal energy.

In one embodiment, the results may be:
(1) The computation complexity was small (2 MHz on an ARM9EJ with 1-cycle memory access.
(2) The filtered signal has intelligible speech and significant reduction in noise power (8-12 dB noise power reduction). Speech power reduction due to the filtering is on the order of 1.5 to 2.5 dB; and SNR improvement on the order of 10 dB.
(3) Listening tests showed that the background lens motor noise is substantially masked by the speech, thereby improving intelligibility.
(4) Listening tests also showed that the narrow-band bandstop (notch) filters have low impact on speech quality (since speech signal consist of fundamental and harmonics).
(5) Listening tests plus cross-coherence plots showed that the lowpass and highpass filters with sloping stopbands do very little to affect speech energy present at low frequencies and speech clarity from high frequencies.
(6) The signal energy is maintained constant by ALC though the cascaded filters reduced the signal energy by 10 dB.

What is claimed is:

1. A method of digital camera operation, comprising the steps of:
(a) applying lens motor operation detection in a digital camera;
(b) when said detection indicates lens motor operation, maintaining an audio bandpass filter operation as active; and
(c) when said detection indicates no lens motor operation, maintaining said audio bandpass filter operation as inactive.

2. The method of claim 1, wherein said audio bandpass filter operation includes filtering input audio with a filter having a passband about 150-3500 Hz.

3. The method of claim 2, wherein said audio bandpass filter operation includes filtering input audio with a filter having a passband about 150-3500 Hz together with at least one notch filter stopband within said 150-3500 Hz passband.

4. The method of claim 1, wherein said audio bandpass filter operation includes marking input audio for subsequent noise suppression.

5. A digital camera with audio/visual capabilities, comprising:
(a) a lens system including a lens motor;
(b) an audio input; and
(c) a processor coupled to said lens system and said audio input, said processor controlling operation of said lens motor, said processor operable to;
(i) when said lens motor is operating, maintaining an audio bandpass filter operation as active; and
(c) when said lens motor is not operating, maintaining said bandpass filter operation as inactive.
